(19) United States
(12) Patent Application Publication
(10) Pub. No.: US 2004/0163665 A1
(43) Pub. Date: Aug. 26, 2004

(54) Teeth cleaning implement

(76) Inventor: Jorge Alvarez, Los Angeles, CA (US)

Correspondence Address: ERIK M. ARNHEM, Second Floor, 4250 Wilshire Blvd., Los Angeles, CA, 90010, US

(21) Appl. No.: 10/371,414

(22) Filed: Feb. 24, 2003

(51) Int. Cl. A61C 15/00

(52) U.S. Cl. 132/322

(57) ABSTRACT

A teeth cleaning implement includes a dental floss supply reel located within a housing that serves as a handle for maniuplating the implement during a teeth cleaning operation. The dental floss is unwound from the reel through an elongated tubular guide that projects from the housing. The dental floss extends from the tubular guide to a second tubular guide, and through this second guide into the housing and back onto the supply reel. The exposed section of the dental floss between the two guides can be moved back and forth in the teeth spaces to achieve a teeth cleaning operation. Periodically the floss supply reel can be rotated to expose a new section of floss.

### FIELD OF THE INVENTION

This invention relates to a teeth-cleaning implement, and particularly to a teeth-cleaning implement that uses dental floss.

### BACKGROUND OF THE INVENTION

Conventional dental floss is a thin flexible string that can be manually moved back and forth through the spaces between a person's teeth to remove food tiny food particles or deposits. In many cases, dental floss removes deposits that cannot be removed with a conventional tooth brush.

Often dental floss comes on a spool, whereby an incremental length of the dental floss string can be unwound from the spool and torn off from the floss on the spool, to use the floss for teeth cleaning purposes. The person grasps the string with his (her) fingers, and pulls the string back and forth through the tooth spaces to effect a cleaning operation.

In another concept, a short length of dental floss is trained between two parallel arms of a small tooth cleaning implement. The implement includes a handle that can be grasped by a person's hand, whereby the implement can be inserted partway into a person's mouth by moving the dental floss back and forth through the tooth spaces. The implement is usually used once or twice, and then discarded (to minimize any build-up of germs in the person's mouth).

One problem with such an implement is that the person has to keep a supply of such Implements on hand, if he (or she) desires to use the implement on a daily basis.

### SUMMARY OF THE PRESENT INVENTION

The present invention relates to a tooth cleaning implement that includes dental floss wound on a supply reel (or spool) within a housing that is sized to serve as a handle. The housing includes two projecting parallel elongated dental floss guides that a person can grasp the housing to insert the elongated guides into the person's mouth.

The dental floss extends from the supply reel through one of the elongated guides, across the space between the two guides, and back through the other guide onto the supply reel. The person can locate the housing so that one elongated guide is in the front of a row of teeth, with an intervening section of the dental floss extending through a tooth space. The person can then manipulate the housing to move the elongated guides toward or away from his (her) teeth, thereby moving the intervening portion of the dental floss within the associated tooth space. Manual manipulation of the housing enables the dental floss to achieve a tooth cleaning operation.

After any given tooth cleaning operation the person can rotate the dental floss supply reel a fraction of a turn, to move the dental floss through the elongated guides and across the intervening space between the two guides. Each fractional turn of the dental floss supply reel effectively replaces the section of dental floss spanning the two elongated guides with a new section of dental floss. The replaced section of dental floss is eventually moved into contact with a disinfectant solution in the housing, so that the dental floss is maintained in a germ-free condition.

Manual rotation of the floss supply reel incrementally advances a clean section of dental floss into the space between the two elongated guides, thereby setting the implement for a new tooth cleaning operation. The total length of dental floss wound around the supply reel is many times the spacing between the two elongated guides, so that the implement can be used repeatedly before the dental floss is fully spent. illustratively, the total length of dental floss is such that the tooth cleaning implement can make in excess of one hundred tooth cleaning operations prior to discarding the implement.

In one particular embodiment of the invention the dental floss supply reel is located within a housing that is adapted to be detachably connected to a casing that contains a small drive motor, a battery power source, and a manual switch for controlling current flow from the battery power source to the motor. When the switch is moved to the circuit-closed position the motor delivers a rotary drive force to the dental floss supply reel, thereby rotating the reel an incremental distance, for resetting the implement for a new teeth cleaning cycle. The person is able to advance the dental floss a predetermined incremental distance without holding the switch in the circuit-closed position for a precise time period. The apparatus is designed to minimize the usage (or wastage) of dental floss.

The motor and power source are located in a casing that is separate from the housing that contains the dental floss reel. When the dental floss has been fully utilized the housing can be discarded and replaced with another similarly constructed housing containing a new supply of dental floss. The dental floss supply housing can be a relatively low cost component that is replaceable without excessive expense.

Specific features of the invention will be apparent from the attached drawings and description of an illustrative embodiment of the invention.

### BRIEF DESCRIPTION OF THE DRAWINGS

FIG. 1 is a sectional view taken through a teeth cleaning implement constructed according to the invention.

FIG. 2 is a sectional view taken on line 2-2 in FIG. 1.

FIG. 3 is a view of another teeth cleaning implement embodying the invention. Portions of the implement are shown in section.

FIG. 4 is a side elevational view of the FIG. 3 teeth cleaning implement, taken in The direction of arrow 4 in FIG. 3. In FIG. 4, a power drive casing is shown separated from a floss supply housing.

FIG. 5 is a schematic diagram of an electric circuit that can be used to control an electric drive motor in the FIG. 3 teeth cleaning implement.

### DESCRIPTION OF A PREFEERRED EMBODIMENT OF THE INVENTION

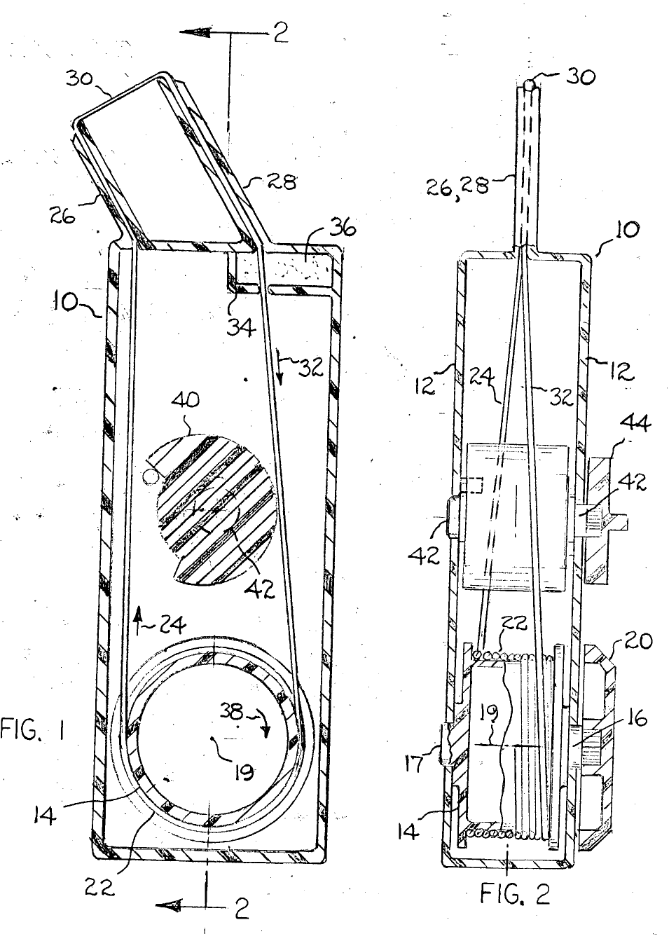

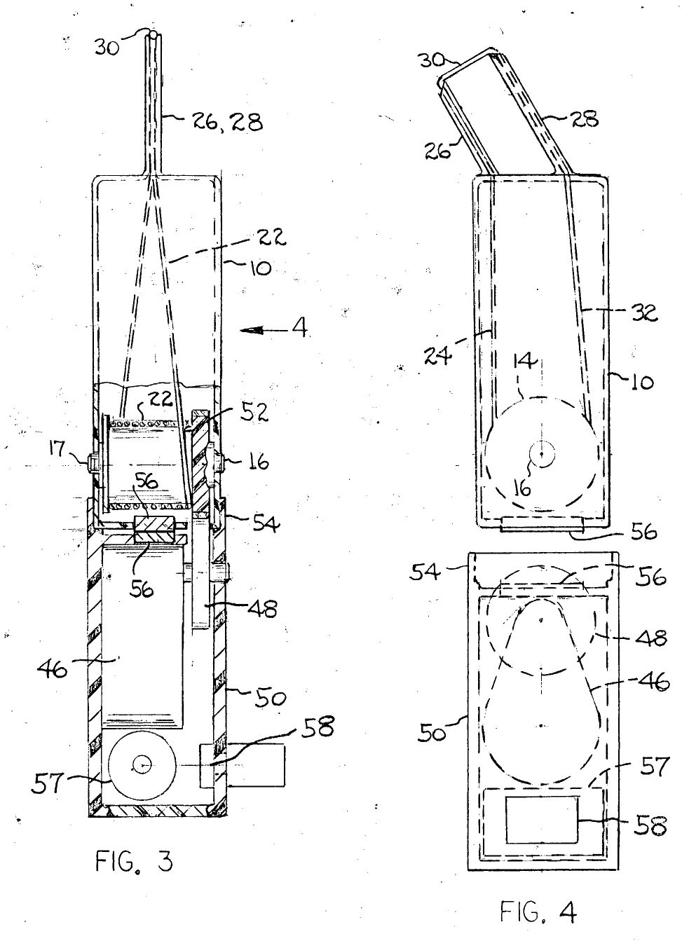

FIGS. 1 and 2 illustrate an illustrative rudimentary teeth cleaning implement embodying features of the invention. FIGS. 3 and 4 show a preferred embodiment of the invention.

Referring to FIGS. 1 and 2, there is shown a teeth cleaning implement that includes an elongated rectangular housing 10 having two spaced parallel side walls 12 that serve to mount a rotary reel (or spool) 14 therebetween. The reel end walls have aligned stub shafts 16 and 17 rotatably seated in circular openings in housing walls 12, whereby the reel can be rotated around axis 19. A manual knob 20 is suitably affixed to stub shaft 16 for powering the reel.

A string-like dental floss 22 is wound a number of times around the reel to provide a reserve supply of dental floss. The dental floss extends from the reel, as at 24, into an elongated tubular guide 26 that projects outwardly from an end wall of housing 10. At the outer end of guide 26 the dental floss is redirected toward a second elongated tubular guide 28 that is spaced a predetermined distance from tubular guide 26. The spacing between the two elongated guides is typically abut one half inch, which enables the implement to be manipulated so that both tubular guides are located within the person's mouth, with the intervening section 30 of the dental floss extending through a tooth-to-tooth space. Rectangular housing 10 is sized to act as a handle for manipulating the implement in a back-and-forth motion of dental floss section 30 through the individual tooth spaces. Housing 10 remains out of the person's mouth.

The dental floss extends through tubular guide 28 into housing 10, as at 32. The housing has an internal partition 34 that forms a small pocket 36 designed to contain a compacted mass of fibrous cotton batting that is saturated with a liquid disinfectant. The disinfectant neutralizes any germs that might be on the dental floss while it is in contact with the cotton batting.

The dental floss proceeds out of pocket 36 and onto a fixed anchorage on reel 14, so that when knob 20 is operated to rotate the reel, the dental floss winds onto the reel. in FIG. 1 the direction of dental floss movement is denoted by arrows 24 and 32. The direction of reel rotation is denoted by arrow 38.

It will be appreciated that the dental floss is in a stationary non-moving state while the implement is being manipulated to achieve a teeth cleaning operation, i.e. a back-and-forth cycling of dental floss section 30 through each tooth space. After a teeth cleaning operation, knob 20 can be turned a predetermined distance, to advance the dental floss from reel 14 (as at 24), through tubular guides 26 and 28, and back onto the reel (as at 32). During such advancement of the dental floss, the exposed tooth cleaner section 30 of the dental floss moves into tubular guide 28, while a replacement section of the floss moves from guide 26 into the intervening space between the two guides.

The knob 20 rotation is pre-selected so that floss section 30 is completely replaced by a single rotation of the knob. For example, assuming that the spacing between elongated guides 26 and 28 is about one half inch, knob 20 will be turned enough (e.g. the equivalent of one inch) to completely replace floss section 30, with some extra travel to ensure complete replacement. Assuming reel 14 has a diameter of about one inch, one revolution of knob 20 will advance the dental floss slightly more than three inch. If each floss advancement is to be about one inch (to ensure complete replacement of floss section 30), then each knob 20 rotation will be about one third revolution.

Suitable degree markings on the housing side wall can serve as reference points for pointer on knob 20, to let the person know how far to turn the knob to ensure complete. replacement of floss section 30 with a new (clean) floss section. The dental floss will have sufficient number of turns on reel 14 to ensure several months usage of the implement for teeth cleaning purposes prior to complete transfer of the floss from the reel (as a 24) and back onto the real (as at 32).

The teeth cleaning action is most effective if floss section 30 is in a taut condition. Such a taut condition can produce frictional resistances that could possibly interfere with reel 14 rotation to achieve the renewal of dental floss section 30. The dental floss should be in a taut condition during a teeth cleaning operation and in a slightly relaxed condition while reel 14 is rotated to achieve floss section 30 renewal.

There is shown in FIG. 1 a rotary cam 40 having aligned stub shafts 42 extending through circular openings in the housing side walls 12, whereby the cam can be rotated by a manual knob 44 affixed to one of the stub shafts. In FIG. 1 position the cam is in light engagement with the dental floss going bac to reel 14, whereby the dental floss is in a relaxed condition. Clockwise rotation of the cam shifts the rightmost surface area of the cam to the right, thereby exerting a rightward pressure on the dental floss, so as to put the dental floss in a taut condition. Cam 40 is set in the FIG. 1 condition when it is desired to rotate reel 14; the cam is rotated to the other condition when it is desired to use the implement for teeth cleaning purposes.

FIGS. 3 and 4 illustrate a preferred embodiment of the invention that is generally similar to the constructive depicted in FIG. 1, except that the dental floss supply reel is rotated by means of an electric motor 46 (instead of manual knob 20).

Motor 46 is located within a casing 50 that is separated from housing 10. The motor drive shaft carries a friction wheel 48 that is in frictional contact with a friction wheel 52 formed on reel (or spool) 14 when housing 10 is connected to casing 50. FIG. 3 shows housing telescopically connected to casing 50. FIG. 4 shows housing 10 disconnected from casing 50.

Casing 50 is constructed with an end flange 54 that forms a socket sized to fit onto the end area of housing 14. The housing can be moved downwardly into the socket from the FIG. 4 position to the FIG. 3 position, whereby the housing and casing are connected together as a single operating unit. Permanent magnets 56 on the mating end surfaces of the housing and casing keep the housing and casing from axial disconnection.

Casing 50 is adapted to be used with any housing 14 that is plugged into the casing socket. When the dental floss in the housing has been fully utilized the housing can be replaced with a new housing containig new, (unused) dental floss. Casing 50 can be used indefinitely, whereas housing 14 is a throwaway item that can be discarded when the dental floss therein has been fully utilized.

Motor 46 is powered by a dry cell battery 57 that is suitably mounted in casing 50. A manual switch 58 having an external actuator is electrically connected to the battery and motor 46, to control current flow from the battery to the motor.

In preferred practice of the invention, each depression (or manual actuation) of the switch actuator produces a predetermined arcuate travel of fricton wheel 52 (and reel 14). Typically, the wheel 52 travel can be about one third revolution (which is sufficient to effect renewal of the exposed dental floss section 30). Motor 46 has an internal speed reducer gearing so that wheel 52 rotation is slow enough for control purposes.

Switch 58 is preferably a momentary-closed (normally open) switch that closes the circuit only while the switch actuator is depressed. A control circuit within casing 50 causes motor 46 to operate for the necessary period to achieve a predetermined arcuate travel of friction wheel 52.

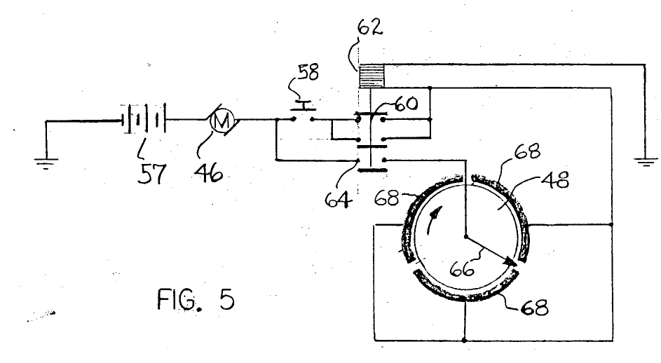

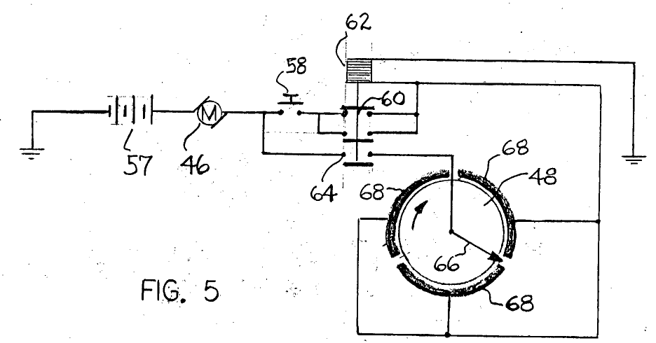

Various motor control circuits can be used, e.g. a capacitive-resistive circuit for achieving a prescribed motor operating period. FIG. 5 shows schematically a rudimentary control circuit that could be used (in lieu of an electronic circuit that might be available commercially).

The FIG. 5 timer circuit includes a momentary-closed switch 58 that closes a set of contacts 60 for energizing a relay coil 62. The coil closes motor-energizer contacts 64 that are in circuit with a rotary slider contact 66 carried by friction wheel 48. Stationary conductors 68 limit the friction wheel travel.

The FIG. 5 timer circuit is illustrative of varius timer circuits that could be used with the momentary switch 58.

The FIG. 3 teeth cleaning implement represents a preferred form of the invention. However, it will be appreciated that the invention can be practiced in various forms and configurations.

What is claimed:

1. A teeth cleaning implement comprising:
a housing sized to serve as a handle;
a dental floss supply reel rotatable in said housing;
two spaced parallel elongated dental floss guides projecting from said housing;
a dental floss string wound on said floss supply reel; said string extending from said supply reel through one of the elongated guides, across the space between said guides, through the other guide, and back onto the supply reel; and reel operator means for intermittently rotating said reel, whereby the dental floss string can be pulled off the supply reel to advance an incremental length of the string into the space between the two elongated guides

2. The teeth cleaning implement of claim 1, wherein said reel operator means is a manual means.

3. The teeth cleaning implement of claim 1, wherein said reel operator means is a manually rotatable knob having a direct mechanical connection with said reel.

4. The teeth cleaning implement of claim 1, wherein said reel operator means comprises an electric motor.

5. The teeth cleaning implement of claim 1, wherein said reel operator means comprises an electric motor, a battery for powering said motor, and a manual switch for controlling current flow from the battery to the motor.

6. The teeth cleaning implement of Clam 1, wherein said reel operator means comprises a casing detachably connected to said housing, and an electric motor located within said casing.

7. The teeth cleaning implement of claim 6, wherein said motor has a drive wheel frictionally connected to said housing reel when said casing is connected to said housing.

8. The teeth cleaning implement of claim 7, wherein said reel operator means comprises a battery for powering said motor, and a manual switch for controlling current flow from the battery to the motor; said battery being located within said casing; said switch comprising a switch-operator located outside the casing for manual actuation of the switch between a circuit-open position and a circuit-closed position.

9. The teeth cleaning implement of claim 8 wherein said switch is a normally-open switch that is momentarily in the circuit-closed condition when the switch operator is activated.

10. The teeth cleaning implement of claim 1, wherein said reel operator means comprises an electric motor, a battery for powering said motor, a manual switch controlling currrent flow to the motor, and a timer circuit for limiting the duration of the motor operating period for a given actuation of the manual switch.

11. The teeth cleaning implement of claim 1, wherein said switch is a normally-open switch that is momentarily in the circuit-closed condition when the switch is manually activated.

12. The teeth cleaning implement of claim 1, and further comprising means in said housing for applying a disinfectant to said dental floss string after said dental floss string has passed through the space between the two elongated guides.

13. The teeth cleaning implement of claim 12, wherein said disinfectant application mans comprises a pocket structure communicating with said other elongated guide, a mass of fibrous absorbent material filling said pocket, and a disinfectant distributed throughout said absorbent matrial.

14. The teeth cleaning implement of claim 1, wherein each said elongated guide is tubular.

15. The teeth cleaning implement of claim 1, and further comprising means in said housing for maintaining said dental floss string in a taut condition when said reel operator means is inactive.

16. The teeth cleaning implement of claim 15, and further comprising manual means for relaxing said dental floss string when the reel operator means is operational.
